(19) United States
(12) Patent Application Publication
(10) Pub. No.: US 2008/0251561 A1
(43) Pub. Date: Oct. 16, 2008

(54) Quick connect base plate for powder actuated tool

(76) Inventors: Chad Eades, Pleasanton, CA (US); Craig T. Pratt, Castro Valley, CA (US)

Correspondence Address: JAMES R. CYPHER, 405 14TH STREET, SUITE 1607, OAKLAND, CA, 94612, US

(21) Appl. No.: 12/005,184

(22) Filed: Dec. 24, 2007

Related U.S. Application Data
(63) Continuation of application No. 11/786,809, filed on Apr. 13, 2007.

(51) Int. Cl. B25C 1/18

(52) U.S. Cl. 227/10

(57) ABSTRACT

A tool is provided with a barrel having a piston for driving a fastener into a substrate, the barrel being mounted for axial movement within a body of the tool and a nose piece being mounted forwardly of the barrel and being at least partially encapsulated by a base plate that connects to the receiver of the tool which encloses the barrel and piston, the present invention permiting ease of assembly and disassembly of the muzzle of the tool—the nose piece and base plate—by making the connection between the base plate and the receiver with a retainer element.

### BACKGROUND OF THE INVENTION

The present invention relates to a power actuated fastening tool for driving a fastener, such as a nail, into a substrate, such as a concrete or steel structure.

Power actuated tools for driving a fastener into a substrate conventionally comprise a barrel from which the fastener is expelled by means of a piston driven by detonation of an explosive charge. The barrel is mounted for axial movement within a receiver assembly which is in turn in the housingor body of the tool. A nose piece is placed forwardly of the barrel and received partially therein and is exposed outside of the housing. A base plate encapsulates most of the nose piece and the forward end of the barrel and attaches to the receiver.

It is necessary to periodically disassemble the tool, particular the muzzle and barrel components for cleaning purposes and replacement of the returner which is generally made of rubber and wears out through repeated use, which requires removal of the base plate and nose piece so that the user can access the barrel, piston and returner. Disassembly can be difficult due to carbon dust build up on the components of the tool. Carbon build-up on fine threaded connections can be particularly troublesome, jamming the connection and making it very difficult to unscrew the base plate from the housing or receiver of the tool. The disassembly and subsequent reassembly, if difficult, can also use up time that can be more productively spent.

### SUMMARY OF THE INVENTION

According to the present invention, there is provided a tool comprising a barrel having a piston for driving a fastener into a substrate, the barrel being mounted for axial movement within a body of the tool and a nose piece being mounted forwardly of the barrel and being at least partially encapsulated by a base plate that connects to the receiver of the tool which encloses the barrel and piston, the present invention permiting ease of assembly and disassembly of the muzzle of the tool—the nose piece and base plate—by means of the connection between the base plate and the receiver.

In a preferred embodiment of the invention a retainer element is carried by the receiver and engages a transverse track on the base plate to cause entrainment of the receiver when the base plate is received in the receiver.

According to another aspect of the present invention, there is provided a power actuated tool for driving a fastener into a substrate upon detonation of an explosive charge, said tool having a barrel and a nose plates placed forwardly of the barrel and both members being retained in the tool by means of a base plate connected to the housing, the base plate being held in assembled relation to the housing by a retainer element and being such that assembly and disassembly can occur by a simple manipulation of the base plate relative to the receiver.

In the preferred embodiment, a latch is provided such that when the base plate and the receiver are connected they are prevented from further rotation until the latch is released.

### BRIEF DESCRIPTION OF THE FIGURES

FIG. 1 is a schematic view, showing the barrel, the housing, the receiver, the piston, the rubber retainer, the nose plate and the base plate of a tool in disassembled relation.

FIG. 2 is a partial cross-section, side view showing the barrel, the housing, the receiver, the piston, the rubber retainer, the nose plate and the base plate in disassembled relation.

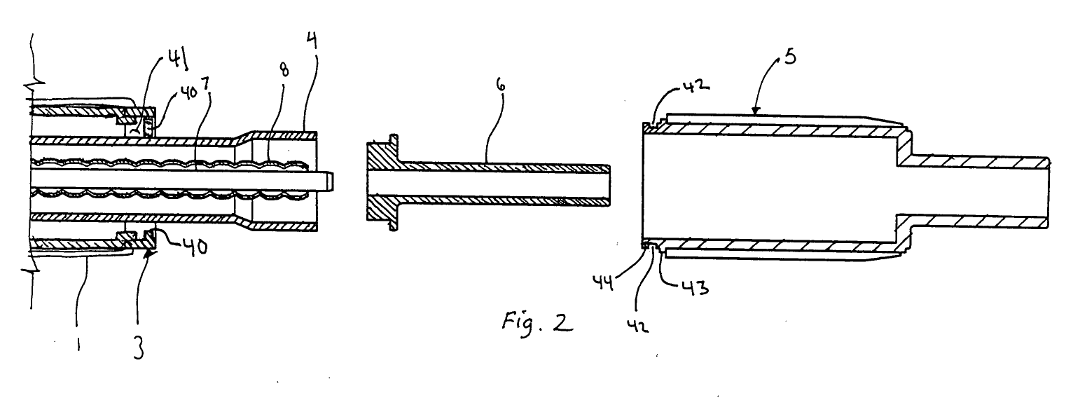

FIG. 3 is a partial cross-section, side view, showing the barrel, the housing, the piston, the rubber retainer, the receiver, the nose plate and the base plate in assembled relation.

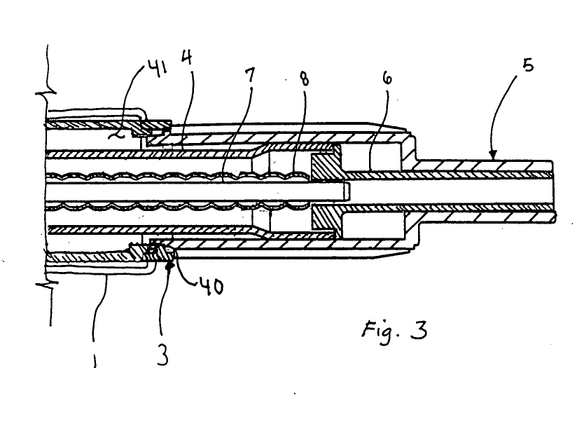

FIG. 4 is a schematic view of another embodiment of the present invention, showing the barrel, the housing, the receiver, the piston, the rubber retainer, the nose plate and the base plate of a tool in disassembled relation.

FIG. 5 is a partial cross-section, side view of the alternate embodiment of FIG. 4, showing the barrel, the housing, the receiver, the piston, the rubber retainer, the nose plate and the base plate in disassembled relation.

FIG. 6 is a schematic view of another embodiment of the present invention, showing the barrel, the housing, the receiver, the piston, the rubber retainer, the nose plate and the base plate of a tool in disassembled relation.

FIG. 7 is a partial cross-section, side view of the alternate embodiment of FIG. 6, showing the barrel, the housing, the receiver, the piston, the rubber retainer, the nose plate and the base plate in disassembled relation.

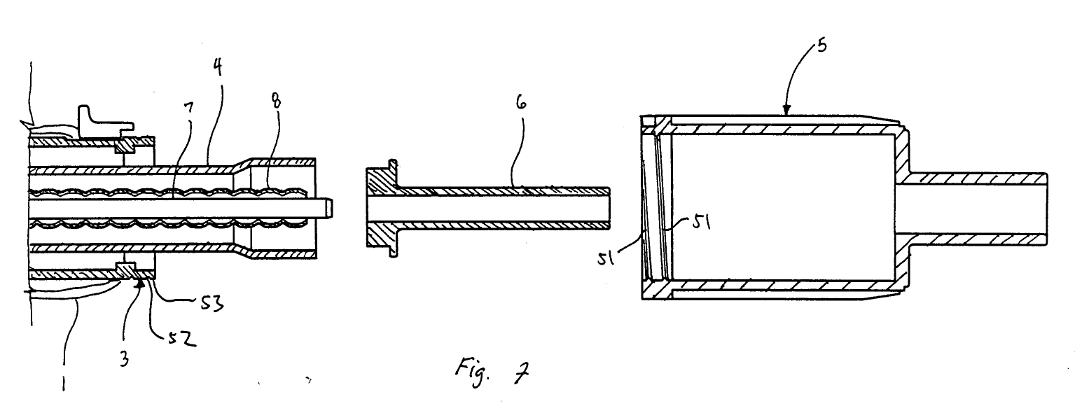

FIG. 8 is a partial cross-section, side view of the alternate embodiment of FIG. 6, showing the barrel, the housing, the piston, the rubber retainer, the receiver, the nose plate and the base plate in assembled relation.

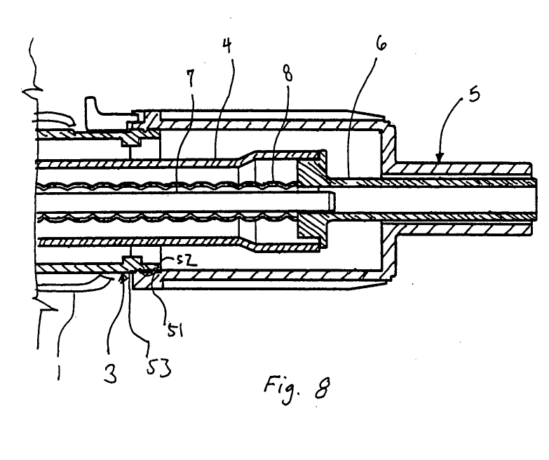

FIG. 9 is a schematic view of another embodiment of the present invention, showing the barrel, the housing, the receive, the piston the nose piece and the base plate in disassembled relation with the base plate-having a magazine.

FIG. 10 is a schematic view of a tool incorporating the present invention.

### DETAILED DESCRIPTION OF THE INVENTION

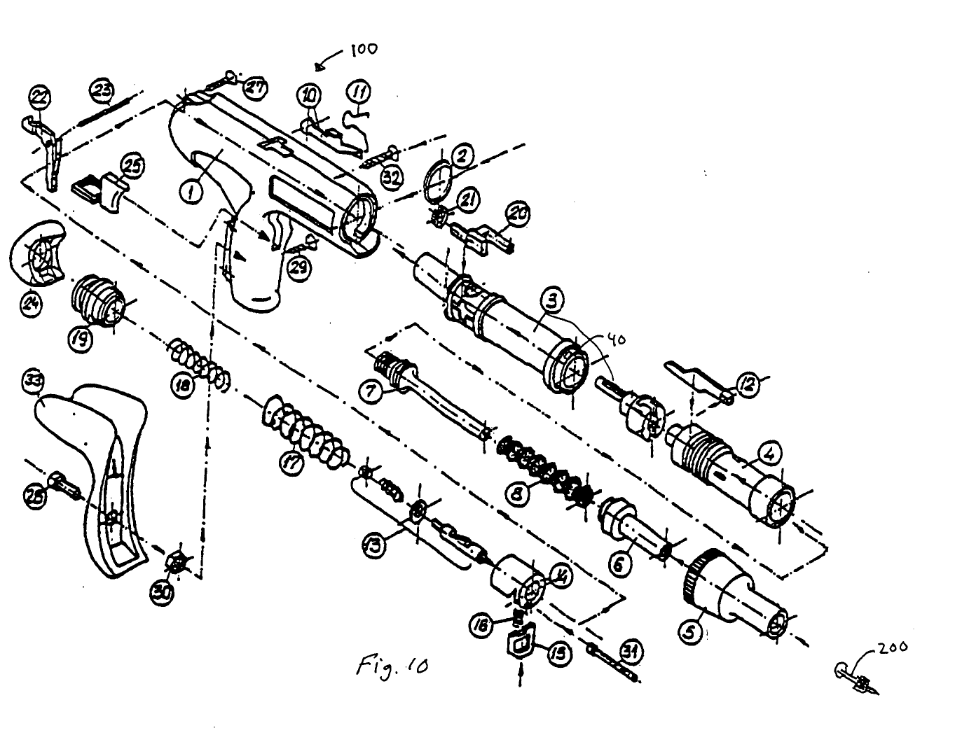

As shown in FIG. 10, the tool 100 has a handle housing 1, with a connecting ring 2. A two-part cylindrical receiver 3 is inserted into the housing 1 and is fixed within the housing 1. The receiver also receives a regulator bolt 20 and a regulator nut 21. A regulator shock absorber assembly 12 is attached to the receiver 3 where the receiver 3 interfaces with a cylindrical barrel 4. The barrel 4 is provided with an advance lever 10 that is restrained by an advance lever spring 11. The cylindrical piston 7 is inserted into the barrel 4. A rubber returner 8 fits over the length of the piston 7 and is surmounted by a cylindrical nose piece 6, which slides over the piston 7. A baseplate 5 fits over and restrains the nose piece 6, returner 8, piston 7 and barrel 4. The interiorily-threaded baseplate 5 is screwed onto the connecting ring 2. A firing pin assembly is inserted into the housing 1 behind the receiver 3. The firing pin assembly includes a cylindrical firing pin mechanism 14, which contains a firing pin 13, a firing pin sear 15, a firing pin sear spring 16 and pushing pin 31. A mechanism spring 17 surrounds the firing pin 13 behind the firing pin mechanism 14 and a firing pin spring 18 is behind the firing pin 13. A receiver plug 19 restrains the firing pin assembly behind the receiver 3 and the plug 19 is covered by a plug cover 24. The firing pin assembly is connected to a trigger 25. The trigger 25 interfaces with a trigger sear lever 22, which is fastened with a trigger lever pin 23. The housing 1 is provided with a rubber handle 33 that is fastened with a bolt 28, preferably M6×15, and a matching nut 30, preferably M6. The housing 1 is closed with a screw 27, preferably D3×16, a bolt 29, preferably D3×22, and a bolt 32, preferably D3×35.

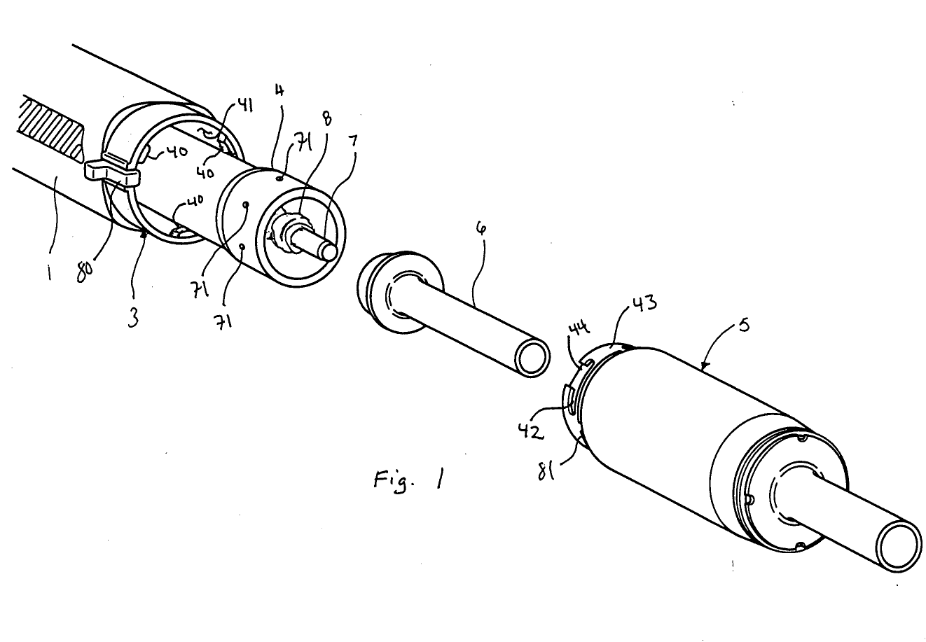

As shown in FIG. 1, a power actuated tool 1 in accordance with the invention comprises a barrel 4 which house a piston 7 the forward portion of which forms a driving pin for driving a fastener 200. The rear end of the barrel 4 acts to receive an explosive charge which, on detonation, propels the piston 7 forwardly within the barrel 4 in order to discharge into a work surface a fastener 200 held within the nose piece 6 at the front of the barrel 4.

As shown in FIG. 1, in the preferred embodiment, the base plate 5 and the receiver 3 of the tool 1 are held in their assembled relationship by retainer elements in the form of pins 40. The retainer pins 14 are preferably mounted at the front end of the receiver 3 and lie on the inner surface 41 of the receiver 3. In the preferred embodiment, the three pins 40 are spaced equally around the circumference of the inner surface 41 of the receiver 3.

When connected, each of the pins 40 engages in a separate transverse track defined by a groove 42 formed on the outer surface 43 of the base plate 5.

Entry of each pin 40 into its associated transverse track 42 on assembly of the base plate 5 to the receiver 3 and removal of the pin 40 upon disassembly of the base plate 5 from the receiver 3 occurs via an axial slot in the form of a grove 44 opening into the transverse track or groove 42.

In the preferred embodiment shown in FIG. 1, each transverse groove 42 opens into an axial slot 44 in the outer surface 43 of the base plate 5.

Assembly of the base plate 5 to the receiver 3 is effected simply by inserting the base plate 5 into the front end of the receiver 3 with the base plate 5 and the receiver 3 angularly aligned so that the three retainer pins 40 will enter axial slots 44 in the base plate 5, and the base plate 5 is pushed forwardly until the transverse grooves 42 reach the position of the three retainer pins 40 at which point the base plate is rotated such that the pins 40 are moved out of axial alignment with the axial slots 44 and are retained from further axial movement by the walls of the transverse grooves 42. When the base plate 5 and the receiver 3 are connected by engagement of the retainer 40 in the transverse track 42, only very limited axial movement of the base plate 5 with respect to the receiver 3 is possible without there also being rotational movement of the receiver 3 with respect to the base plate 5, providing a secure enclosure for the barrel 4 contained therein.

Disassembly of the two barrel sections is effected by the reverse action. It will thus be appreciated that disassembly and subsequent reassembly of the base plate 5 to the receiver 3 as may be periodically required for cleaning purposes is effected by simple axial and rotational movement of base plate 5 relative to the receiver 3.

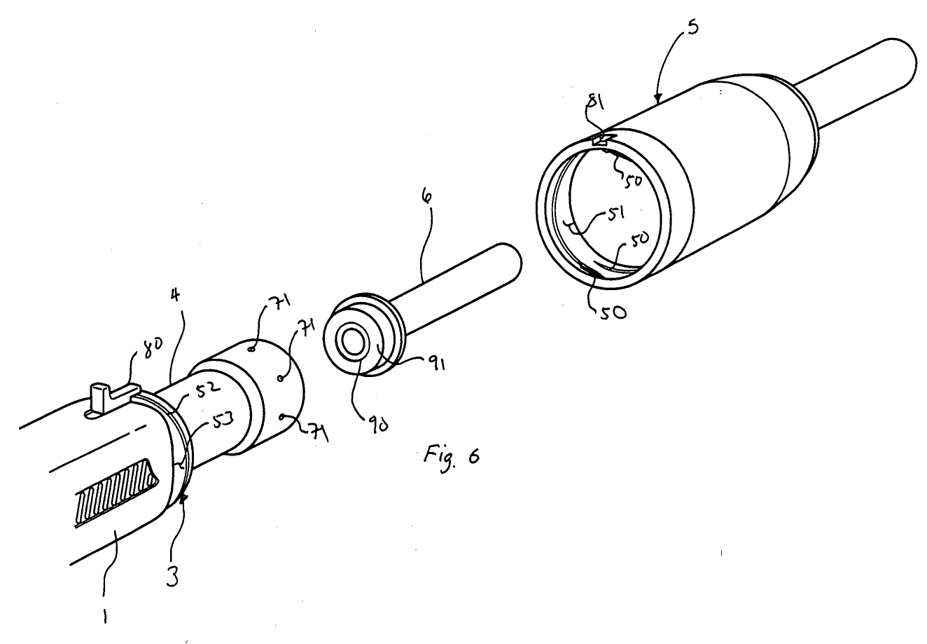

In the embodiment shown in FIG. 6, the retainer is multi-start threads 50 located on the inner surface 51 of the base plate 5, and the multi-start threads 51 interface with transverse slots 52 on the outer surface 53 of the receiver 3. The multi-start threads 50 provide a quick connection between the base plate 5 and the receiver 3 given a small angular rotation between the base plate 5 and the receiver 3. It is preferable that the rotation be less than 360 degrees.

The multi start threads 51 could also be mounted on the outer surface 43 of the base plate 5, and the transverse slots 52 that mate with them could be mounted on the inner surface 41 of the receiver 3. Similarly, the multi-start threads 51 could also be mounted on the outer surface 53 of the receiver 3, and the transverse slots 52 that mate with them could be mounted on the inner surface 51 of the base plate 5. Similarly, the multi-start threads 51 could also be mounted on the inner surface 41 of the receiver 3, and the transverse slots 52 could be mounted on the outer surface 43 of the base plate.

Similar to the embodiment shown in FIG. 6, pins 40 could be mounted on the inner surface 41 of the base plate 5, and the transverse track 42 with connecting axial slot 44 could be mounted on the outer surface 53 of the receiver 3.

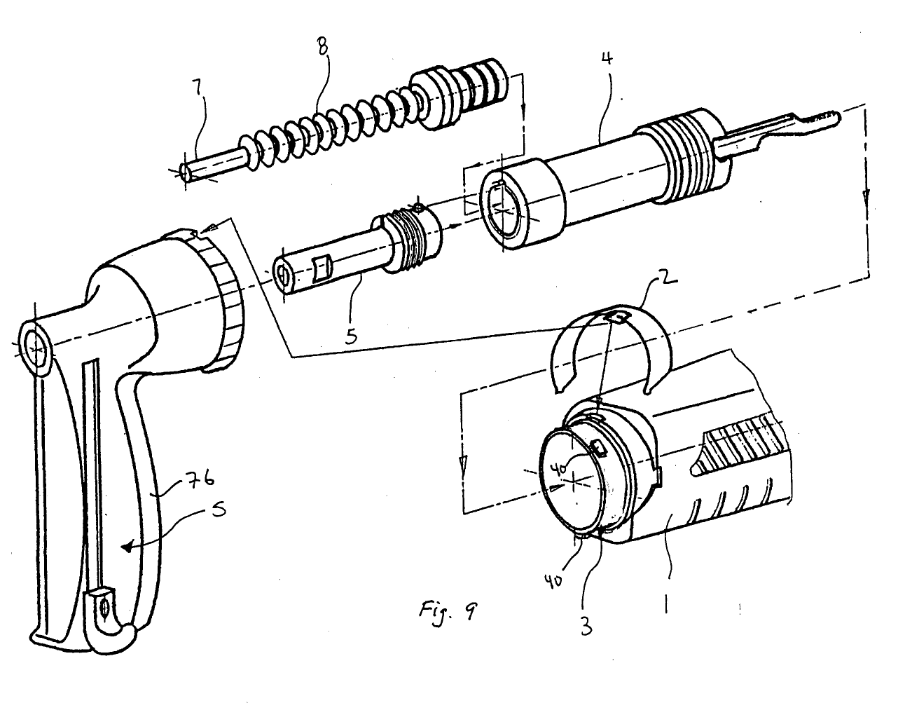

Also similarly, and as partially shown in FIG. 9, pins 40 could be mounted on the outer surface 53 of the receiver 3, and the transverse track 43 with connecting axial slot 44 could be mounted on the inner surface 51 of the base plate 5.

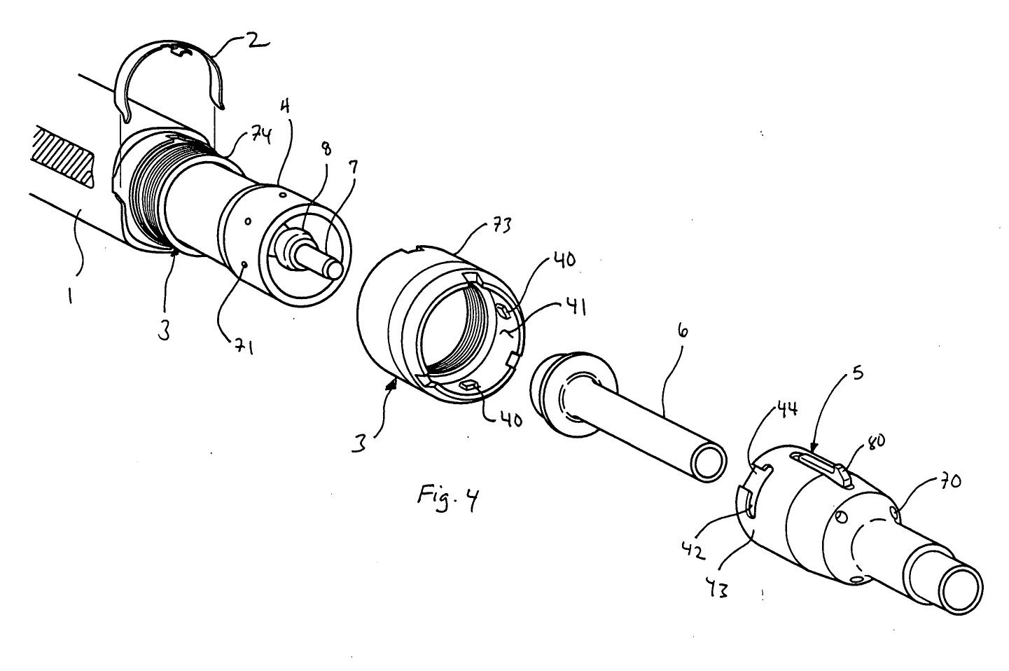

As shown in FIG. 4, openings 70 can be formed in the base plate 5 for exhausting gas, and openings 71 can be formed in the barrel 4 for exhausting gas.

As is shown in FIG. 4, the receiver 3 which receives the barrel 4 can be made up of multiple parts. In the embodiment shown in FIG. 4, the receiver 3 has an outer adapter 73 and base 74. The outer adapter, in this embodiment, is threaded onto the base 74.

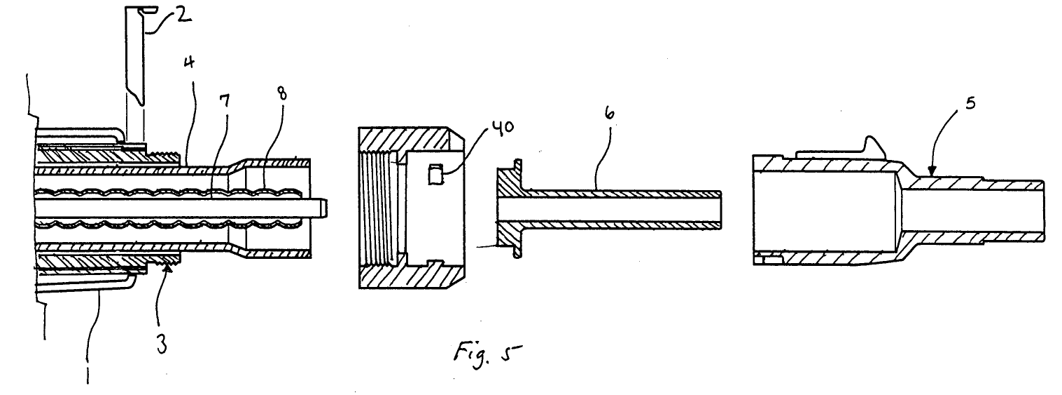

As is also shown in FIG. 4, the connecting ring 2 is used to keep the base plate 5 from rotating with respect to the retainer 3, or with the retainer 3 shown in FIGS. 4 and 5, the connecting ring keeps the outer adapter 73 of the retainer 3 from rotating with respect to the base 74 of the retainer 3.

As shown in FIG. 9, the base plate 6 can be formed with a magazine 76 for carrying multiple fasteners 200, or a magazine could be attached to the base plate 5.

In addition to the quick-connecting baseplate 5 (which eliminates problems with the baseplate threads being clogged with carbon deposits), the preferred embodiment of the tool 100 of the preferred embodiment also includes a free-floating nosepiece 6.

In the preferred embodiment, the base plate 5 and nose piece are made from a heat-treated, low allow steel 42CRmo4 that conforms or closely conforms to the following standards: DIN 1.7225, AISA 4340 and UNDS G43400. BASF provides such a steel under the identifier Catamold 4340.

As shown in FIGS. 1 and 6, in the preferred embodiment a latch 80 can connect to an indent 81 or notch to prevent relative rotation between the base plate 5 and the receiver 3 once they are connected. As shown in FIG. 1, the latch 80 is mounted on the receiver 3. As shown in FIG. 4, the latch 80 is mounted on the base plate 5.

As shown in FIG. 1, in the preferred embodiment the outer surface 43 of the base plate 5 where the retainer 40 is received closely matches the inner surface 41 of the receiver 3.

Similarly, as shown in FIG. 6, when the base plate 5 is received over the receiver 3, the inner surface 51 of the base plate 5 where the retainer 50 is places closely matches the outer surface 53 of the receiver 3 where the retainer will be entrained.

In the preferred embodiment the end of the nose piece 6 is formed with a groove 90 at its end 91 for receiving the end of the returner 8.

In the preferred embodiment, the tool 100 is a power actuated tool, but the piston 7 could be operated by other means, such as a outside source of pressurized liquid or air, or motor that drives the piston 7.

We claim:

1. A tool, comprising
a. a barrel having a front end;
b. a piston at least partially received in the barrel;
c. a nose piece at least partially inserted in the front end of the barrel;
d. a receiver at least partially receiving the barrel;
e. a base plate connected to the receiver and at least partially encapsulating the nose piece
e. a retainer element interposed between the base plate and the receiver to cause entrainment of the base plate with the receiver, the configuration being such that assembly and disassembly of the base plate and the receiver can be accomplished by limited relative rotational movement and axial movement between the base plate and the receiver.

2. The tool of claim 1, wherein:
a. the retainer is one or more pins located on the inner surface of the receiver;
b. the base plate is formed with one or more transverse tracks on the outer surface of the base plate, each transverse track having an axial slot in communication with the transverse track, and each transverse track can receive a pin and each axial slot can receive a pin, and when the base plate is fully connected to the receiver each pin is received in a transverse track, and during assembly or disassembly of the base plate from the receiver each pin travels through an axial slot to reach a transverse track in communication with an axial slot.

3. The tool of claim 1, wherein:
a. the retainer is one or more pins located on the outer surface of the receiver;
b. the base plate is formed with one or more transverse tracks on the inner surface of the base plate, each transverse track having an axial slot in communication with the transverse track, and each transverse track can receive a pin and each axial slot can receive a pin, and when the base plate is fully connected to the receiver each pin is received in a transverse track, and during assembly or disassembly of the base plate from the receiver each pin travels through an axial slot to reach a transverse track in communication with an axial slot.

4. The tool of claim 1, wherein:
a. the retainer is one or more pins located on the inner surface of the base plate;
b. the receiver is formed with one or more transverse tracks on the outer surface of the receiver, each transverse track having an axial slot in communication with the transverse track, and each transverse track can receive a pin and each axial slot can receive a pin, and when the base plate is fully connected to the receiver each pin is received in a transverse track, and during assembly or disassembly of the base plate from the receiver each pin travels through an axial slot to reach a transverse track in communication with an axial slot.

5. The tool of claim 1, wherein:
a. the retainer is one or more pins located on the outer surface of the base plate;
b. the receiver is formed with one or more transverse tracks on the inner surface of the receiver, each transverse track having an axial slot in communication with the transverse track, and each transverse track can receive a pin and each axial slot can receive a pin, and when the base plate is fully connected to the receiver each pin is received in a transverse track, and during assembly or disassembly of the base plate from the receiver each pin travels through an axial slot to reach a transverse track in communication with an axial slot.

6. The tool of claim 1, wherein:
a. the retainer is two or more multi-start threads located on the inner surface of the base plate;
b. the receiver is formed with two or more transverse tracks on the outer surface of the receiver, and each transverse track can receive a multi-start thread, and when the base plate is fully connected to the receiver each multi-start thread is received in a transverse track, and during assembly or disassembly of the base plate from the receiver each multi-start thread travels through a transverse track less than one complete rotation of the base plate with respect to the receiver.

7. The tool of claim 1, wherein:
a. the retainer is two or more multi-start threads located on the outer surface of the base plate;
b. the receiver is formed with two or more transverse tracks on the inner surface of the receiver, and each transverse track can receive a multi-start thread, and when the base plate is fully connected to the receiver each multi-start thread is received in a transverse track, and during assembly or disassembly of the base plate from the receiver each multi-start thread travels through a transverse track less than one complete rotation of the base plate with respect to the receiver.

8. The tool of claim 1, wherein:
a. the retainer is two or more multi-start threads located on the inner surface of the receiver;
b. the base plate is formed with two or more transverse tracks on the outer surface of the base plate, and each transverse track can receive a multi-start thread, and when the base plate is fully connected to the receiver each multi-start thread is received in a transverse track, and during assembly or disassembly of the base plate from the receiver each multi-start thread travels through a transverse track less than one complete rotation of the base plate with respect to the receiver.

9. The tool of claim 1, wherein:
a. the retainer is two or more multi-start threads located on the outer surface of the receiver;
b. the base plate is formed with two or more transverse tracks on the inner surface of the base plate, and each transverse track can receive a multi-start thread, and when the base plate is fully connected to the receiver each multi-start thread is received in a transverse track, and during assembly or disassembly of the base plate from the receiver each multi-start thread travels through a transverse track less than one complete rotation of the base plate with respect to the receiver.

10. The tool of claim 1, further comprising:
a. a latch mounted on the receiver;
b. a notch formed in the base plate that receives and engages the latch when the base plate and receiver are fully connected such that rotation of the base plate with respect to the receiver is prevented.

11. The tool of claim 2, further comprising:
a. a latch mounted on the receiver;
b. a notch formed in the base plate that receives and engages the latch when the base plate and receiver are fully connected such that rotation of the base plate with respect to the receiver is prevented.

12. The tool of claim 2, further comprising:
a. a latch mounted on the base plate;
b. a notch formed in the receiver that receives and engages the latch when the base plate and receiver are fully connected such that rotation of the base plate with respect to the receiver is prevented.

13. The tool of claim 6, further comprising:
a. a latch mounted on the receiver;
b. a notch formed in the base plate that receives and engages the latch when the base plate and receiver are fully connected such that rotation of the base plate with respect to the receiver is prevented.

14. The tool of claim 1, further comprising:
a. a latch mounted on the base plate;
b. a notch formed in the receiver that receives and engages the latch when the base plate and receiver are fully connected such that rotation of the base plate with respect to the receiver is prevented.
